(19) United States
(12) Patent Application Publication
(10) Pub. No.: US 2016/0117469 A1
(43) Pub. Date: Apr. 28, 2016

(54) HEALTHCARE SUPPORT SYSTEM AND METHOD

(71) Applicant: KONINKLIJKE PHILIPS N.V., Eindhoven (NL)

(72) Inventors: ALEKSANDRA TESANOVIC, EINDHOVEN (NL); ARVID RANDAL NICOLAAS, TILBURG (NL); JAN JOHANNES GERARDUS DE VRIES, EINDHOVEN (NL); GIJS GELEIJNSE, GELDROP (NL); JENNIFER CAFFAREL, EINDHOVEN (NL); JOLIJN TEUNISSE, EINDHOVEN (NL); JOYCA PETRA WILMA LACROIX, EINDHOVEN (NL)

(73) Assignee: KONINKLIJKE PHILIPS N.V., Eindhoven (NL)

(21) Appl. No.: 14/889,173

(22) PCT Filed: Jun. 4, 2014
(86) PCT No.: PCT/IB2014/061936

§ 371 Date: Nov. 5, 2015

Related U.S. Application Data
(63) Continuation-in-part of application No. 13/909,779, filed on Jun. 4, 2013.

(51) Int. Cl. G06F 19/00

(52) U.S. Cl. CPC G06F 19/3437; G06F 19/322; G06F 19/3481

(57) ABSTRACT

A healthcare support system for determining care for a patient and a corresponding healthcare support method are presented. The healthcare support system comprises a processor and a computer-readable storage medium, wherein the computer-readable storage medium contains instructions for execution by the processor, wherein the instructions cause the processor to perform the steps of obtaining patient data, assessing a clinical need of the patient, proposing a clinical outcome, and determining a service to be provided to the patient for said clinical need and said proposed clinical outcome based on a service-outcome-need model. Further, the present invention relates to a computer-readable non-transitory storage medium and a computer program.

### FIELD OF THE INVENTION

The present invention relates to a healthcare support system for determining care for a patient comprising a processor and a computer-readable storage medium, wherein the computer-readable storage medium contains instructions for execution by the processor. Further, the present invention relates to a corresponding healthcare support method, a computer-readable non-transitory storage medium and a computer program.

### BACKGROUND OF THE INVENTION

Clinical decisions support (CDS) systems have become a leading response to the growing demand for the promotion of standards-based care delivery. CDS tools are important components of clinical information technology (IT) systems and may directly improve patient care outcomes and the performance of healthcare organizations.

A patient with a chronic condition is normally managed across care settings. The patient starts his journey at the hospital ward, is discharged home and continues care at home with supervision of an out-patient clinic or a general practitioner.

US 2010/0082369 A1 discloses a system and method for interconnected personalized digital health services. As a part of their digital services, US 2010/0082369 A1 further discloses that it would be desirable to generate a personalized care plan for a patient based on health information from a database. The care plan should be generated by applying some form of tools. However, a solution to this problem is not presented in detail.

As a solution, US 2007/0244724 A1 discloses the use of a historic reference database for identifying patient records that closely correspond to the patient being treated. A physician is presented with an outcome history and a treatment history of historic patients that can serve as indicators for a likely outcome and proposed course of treatment for the present patient.

However, the way of determining care for a patient can be further improved. The solution disclosed in US 2007/0244724 A1 is limited to recommendations that have been applied to a historic patient population. Such a system would be limited to repeating past recommendations but does not foster the progress of new treatments or the use of an existing treatment in a new context.

### SUMMARY OF THE INVENTION

It is an object of the present invention to provide a healthcare support system and healthcare support method that better assist in determining the right service to be provided to the patient. It is a further object of the present invention to improve care across different care settings.

In a first aspect of the present disclosure, a healthcare support system for determining care for a patient is presented that comprises a processor and a computer-readable storage medium, wherein the computer-readable storage medium contains instructions for execution by the processor, wherein the instructions cause the processor to perform the steps of:

obtaining patient data,

assessing a clinical need of the patient,

proposing a clinical outcome, and

determining a service to be provided to the patient for said clinical need and said proposed clinical outcome based on a service-outcome-need model.

In a further aspect of the present disclosure a corresponding healthcare support method is presented.

In yet other aspects of the present disclosure, there are provided a computer program which comprises program code means for causing a computer to perform the steps of the healthcare support method when said computer program is carried out on a computer, and a computer-readable non-transitory storage medium containing instructions for execution by a processor, wherein the instructions cause the processor to perform the steps of the claimed healthcare support method.

Preferred embodiments of the disclosure are defined in the dependent claims. It shall be understood that the claimed method, computer program, and computer-readable non-transitory storage medium have similar and/or identical preferred embodiments as the claimed system and as defined in the dependent claims.

Compared to known systems and methods, the system and method according to the present invention improves the determination of a service to be provided to the patient. To optimize the care and to improve clinical outcomes, the inventors have found that appropriate services not only have to be provided at the hospital, but also need to be put in place for example at the patient's home or at intermediate care facilities to detect deteriorations at an early stage and/or to empower the patient's self-care abilities.

Today, such services are assigned to the patient ad-hoc, are exclusive for one care setting, or are not able to adapt as the patient condition changes over time. For example, a home health agency assigns certain services to the patient. These services, however, might not necessarily be recommended or endorsed by the primary care setting, for example a treating physician at the hospital.

Compared to known systems and methods, the present disclosure not only provides a service that addresses the current need of the patient but also takes a proposed clinical outcome into account. Thereby, the determined services can be calibrated across care settings and through the natural progression of patients' condition and co-morbidities to ensure the best care for a particular patient.

In one aspect, the invention provides for a healthcare support system. A healthcare support system as used herein encompasses an automated system for determining a service to be provided to the patient for a clinical need and a proposed clinical outcome.

The healthcare support system comprises a processor and a computer-readable storage medium.

A ‘computer-readable storage medium’ as used herein encompasses any storage medium which may store instructions which are executable by a processor of a computing device. The computer-readable storage medium may be referred to as a computer-readable non-transitory storage medium. The computer-readable storage medium may also be referred to as a tangible computer-readable medium. In some embodiments, a computer-readable storage medium may also be able to store data which is able to be accessed by the processor of the computing device. Examples of a computer-readable storage medium include, but are not limited to: A floppy disk, a magnetic hard disk drive, a solid state hard disk, flash memory, a USB thumb drive, Random Access Memory (RAM), Read Only Memory (ROM), an optical disk, a magneto-optical disk, and a register file of the processor. Examples of optical disks include Compact Disks (CD) and Digital Versatile Disks (DVD), for example CD-ROM, CD-RW, CD-R, DVD-ROM, DVD-RW, or DVD-R disks as well as Blue Ray Disks (BD). The term computer-readable storage medium also refers to various types of recording media capable of being accessed by the computer device via a network or communication link. For example, data may be retrieved over a modem, over the internet or over a local area network.

A ‘processor’ as used herein encompasses an electronic component which is able to execute a program or machine executable instruction. References to the computing device comprising ‘a processor’ should be interpreted as possibly containing more than one processor. The term computing device should also be interpreted to possibly refer to a collection or network of computing devices each comprising a processor. Many programs have their instructions performed by multiple processors that may be within the same computing device or which may even be distributed across multiple computing devices.

The term ‘clinical need’ as used herein encompasses a need following from a disease, symptom, and/or mental or physical status that affects the patient's current and/or future health or well-being. The term ‘outcome’ or ‘clinical outcome’ relates to an expected mental and/or physical status of the patient after an intervention such as providing a service to the patient. The decision to do nothing or not to change an existing treatment can also be seen as an intervention with an corresponding outcome. Thereby, the outcome also covers whether the patient requires a medical facility or can be taken care of at home. Thus the clinical outcome also comprises the results readmission or self-care. A ‘service’ encompasses any measure provided to the patient for treatment of a medical condition in particular for addressing a clinical need.

In a preferred embodiment the service-outcome-need model provides a relationship between a service provided to the patient, a clinical outcome and a clinical need of the patient. Thus, the determination or recommendation of a service to be provided to the patient not only depends on the current patient status and current clinical need of the patient, but also takes into account a proposed clinical outcome. Thereby, not only the circumstances of the current care setting, for example a hospital, are taken into account but also the circumstances of a target care setting for example, care by an out-patient clinic or self-care at home, are taken into account when determining the service to be provided. This ensures, that not only services are offered that are exclusive for one care setting. Thereby, services can be recommended that are recommended or at least endorsed by different care settings that are relevant for the patient. This is particularly important for a patient with a chronic condition who is normally managed across care settings. For example there are several options for a service to be provided but only one of them is supported by a hospital ward, a home case care under supervision. Hence, this supported service is assigned to the patient. In other words, an aspect of the present invention relates to a system that determines care for a patient with a chronic condition and aligns or calibrates care across different care settings.

In an embodiment, the service-outcome-need model further comprises an ontology, which ontology gives a relationship of clinical needs for a clinical domain or a disease. An ontology is a source of structured knowledge that allows a computer to reason about that knowledge. For example, from a (dedicated medical) ontology it can be derived that there is a relation between a particular service and (clinical) outcome, which enables a computer system to suggest the application of the service if the outcome is of importance to a patient. Alternatively, an ontology provides relations between clinical needs for example provides structured information about which clinical needs depend upon each other in form of a mathematical graph. For example an ontology based on the ICD-10 system allows drawing automated conclusions such as ‘heart failure’ is a ‘cardiac condition’. As a further example, SNOMED is a standardized knowledge source where medical conditions and their relations are defined. Extensions to such a knowledge source, for example extensions that fit local needs, conditions or situations, can easily be made. For example, it may be used to derive that a cardiac echo may give insights into the patient's left ventricular ejection fraction.

In an advantageous embodiment the healthcare support system further comprises a service database, wherein for each service there is an instance of the service-outcome-need model.

Preferably, the instructions further cause the processor to perform the step of creating said service database based on patient data. Patient data can be obtained from various sources, such as an electronic health record (EHR) which can be part of a hospital information system (HIS). The patient data of a large patient population can serve as an input. Preferably, an electronic patient summary (SUEP) is provided which provides a tailored overview of the status of one ore more hospitalized patients.

In an advantageous embodiment the creation of said service database further comprises obtaining data from clinical studies and/or clinical expert. Data from clinical studies can be particularly relevant, because of the typically well-controlled boundary conditions of a clinical study. Thus, the service database is advantageously enriched by further sources. Optionally, this includes the mining of medical journals. Thus, the system and method according to the present invention are broader than conventional solutions in the sense that additional knowledge sources, such as ontologies, or knowledge mined from medical journals can be used. This allows the recommendation of a service for a specific patient or patient group for which the service was not or only infrequently applied before. Thereby, the proposed method and system provide recommendations that are different from the traditional way of working in the hospital.

In another embodiment, the instructions further cause the processor to perform the step of updating said service database based on the obtained data. This can be seen as a feedback mechanism for providing input on the effectiveness of a proposed service for a particular patient. Thereby, proposed services could change based on the received feedback.

In an advantageous embodiment, the healthcare support system is a self-adapting system. Thus, the system may continuously determine the most appropriate service to be provided to the patient to improve the specific clinical need of this particular patient. These adjustments may be computed each time when the patient's health status is changed, for example after a hospitalization or an out-patient clinic visit or during home monitoring using these services. Correspondingly, the electronic patient summary (SUEP) can updated using home health services, i.e., based on data collected in the at-home situation. In particular, when the collected data changes over time, or parameters show out-of-range values, these aspects can be fed into the SUEP. An integration between in-patient care and out-patient supervision can thus provide a more effective care coordination, for example, for supporting a chronic patient throughout a care continuum or care cycle. This can take place over a longer period of time and/or across care settings.

In a further embodiment, the service to be provided to the patient is determined when new patient data is obtained and/or when the service-outcome-need model is updated. For example, feedback from a different patient or different set of patient provides input on the effectiveness of a proposed service. In response, the proposed services for a particular group of patients can be changed.

In a further embodiment, the service-outcome-need model comprises patient classes. In a further refinement, patient class data associated with said patient classes is based on patient data from a historical patient population. A class can be based on historic patient data and can be for example created using either machine learning techniques only or with input and/or validation by a clinical expert. As an advantage, the use of patient classes simplifies data processing.

In a further embodiment, the patient data is obtained based on elements selected for an electronic patient summary (SUEP). An electronic patient summary can be tailored to information which is considered to be relevant. Settings of the electronic patient summary can reflect the condition of the patient and/or care delivery standards as propagated by the hospital or caregiver. Advantageously, the selection of elements limits the amount of data to be processed. With the patient summary, a clinician can be offered a mechanism to tailor his view of the patient based on aspects that are of particular worry. Hence, in an embodiment, a clinician's patient summary can be incorporated. In a further refinement, the electronic patient summary provides a selection of quality-guided care and information aspects specific to a patient condition. An ‘element’ as used herein can refer to any information available for the patient such as laboratory results or vital sign measurements.

In a further embodiment, the determination of the service to be provided to the patient is further on elements selected for a patient summary. For example, a service such as a patient monitor for home monitoring can be assigned to the patient based on elements selected for a patient summary. An advantage of this embodiment is that the service to be provided to the patient is focused on aspects which are considered relevant for the patient summary. Alternatively, the elements selected for the patient summary can be given more weight compared to further patient data in determination of the service to be provided to the patient.

Furthermore, in an example, a service can be determined for continuously acquiring relevant data for the patient summary also when the patient is at home. Hence, relevant data for the patient summary will be readily available when the patient is hospitalized again and the treating physician at the hospital is assisted in diagnosing the patient faster.

In a further embodiment, the patient data comprises psycho-social data and the step of determining a service to be provided to the patient further comprises determining how the service is to be provided based on the psycho-social data. An advantage of this embodiment is that the impact of a service on the patient can be enhanced and that the clinical and/or financial outcomes of that particular patient can be optimized. It has been found that the impact of a specific type of service to be provided to the patient can be improved by delivering in such a way that it fits the personal situation and preferences of the patient, i.e. the delivery of the service can be optimized. How the service is to be provided can be seen as an attribute of the service. For example, the service is extra clinical visits. These extra clinical visits can be extra face to face visits versus extra visits through video contact. The first option potentially requires extra travelling whereas the second option requires a certain technical expertise and/or willingness to engage in video contact. Based on the psycho-social data a preferred option can be determined without necessarily incurring much additional cost. Further non-limiting examples include adjusted settings for automatic alerts, or motivational support by a professional health coach compared to motivational support by a trained family member. By considering the variations in intensity of specific services, dependent on how the service is to be provided to the patient, the intensity of costly care can be much more closely adapted to the needs of the patient and thereby delivered in a more cost-effective manner. Hence, it is not only the service itself, but also its delivery in terms of type and intensity that will affect the patient's therapy adherence and clinical outcomes. Within a certain service, there exist a wide range of possible intensity levels and delivery forms. For example, for home nurse visits, the timing frequency, nature of visits, person visiting, and communication style can all be varied. These differences in delivery and intensity of a particular service can have a large impact on adherence and outcome. Optionally, the delivery, i.e., the way how the service is provided to the patient, is adaptive. Hence, the system can be configured to update how the service is to be provided to the particular patient.

In a further aspect of the present disclosure, a healthcare support system for determining care for a patient is presented that comprises a processor and a computer-readable storage medium, wherein the computer-readable storage medium contains instructions for execution by the processor, wherein the instructions cause the processor to perform the steps of obtaining patient data, wherein the patient data comprises psycho-social data, assessing a clinical need of the patient, and determining a service to be provided to the patient for said clinical need and determining how the service is to be provided to the patient based on the psycho-social data. In other words, the system not only determines what service should be provided to the patient but also determines how the service should be provided to the patient. Hence, not only the service can be tailored to the patient's needs but also, for example, the communication style with which the service is offered. Thereby the effectiveness of the service can be improved and the adherence can be increased.

For example, in current care settings a best practice care plan is often delivered on the same level of intensity and way of delivery to a plurality of patients regardless of their medical history or tendencies in self-management or actual needs. For example, intensive care is delivered as a part of one delivery model that is defined by the hospital regardless of actual patient needs, resulting in high expenditures, not optimizing the care intensity delivery to actual patient needs. A further challenge with current systems is that often only clinically high risk patients get more intensive care, whereas for example a stable patient with a tendency not to use medications as prescribed will be missed in such an assessment and might therefore end up being readmitted and consequently also at high risk. Correspondingly, for a compliant patient a reduced level of intensity and/or more self-care with associated lower cost can be well-suited for an optimum outcome. As described above, it has been found that the effectiveness of a service can improved by the nature of its way of delivery and the required level of intensity of the service that would provide optimal outcome based on the patient's psycho-social data. The optimal delivery strategy may again require continuous revision.

Determination how the service is to be provided to the patient, i.e. the delivery type and/or delivery level and/or intensity of a service, based on the psycho-social data may include an assessment of one or more of a patient's communication profile, a patient's psychological profile and patient's social profile. Determining what service, i.e. the type of service, is provided may include an assessment of a clinical risk profile and/or of an expected cost profile.

In an embodiment, data-mining can be applied on data from a care provider and/or self-reported data obtained form a patient, in particular using sensors at home and/or data from sensors at the care provider. In an embodiment, a data storage can be provided with a holistic patient model, for example, comprising a psycho-social model comprising the communication profile, psychological profile and/or social profile, and a cost-risk profile comprising the clinical risk profile and/or the cost profile. Risk matching and or cost-risk matching can be performed for determining the type of service. Psycho-social matching can be performed for determining how the service is to be provided to the patient. Advantageously, recommendations are provided based on a combination of knowledge-based and data-mining approaches to determine and/or update the service and how the service is to be provided to the particular patient.

In conclusion, the determination of services provided to a patient is improved and, in particular, takes the outcome and different care settings into account.

### BRIEF DESCRIPTION OF THE DRAWINGS

These and other aspects of the invention will be apparent from and elucidated with reference to the embodiments described hereinafter. In the following drawings

FIG. 1 illustrates the journey of a patient through different care settings;

FIG. 2 shows a schematic diagram of a first embodiment of the proposed healthcare support system;

FIG. 3 shows a flow chart of a first embodiment of the proposed healthcare support method;

FIG. 4A shows a representation of the service-outcome-need model;

FIG. 4B shows a first instantiation of the service-outcome-need model;

FIG. 4C shows a second instantiation of the service-outcome-need model;

FIG. 5 illustrates the creation of a services database;

FIG. 6 shows the creation of a clinical-needs ontology;

FIG. 7 shows an example of a clinical needs ontology;

FIG. 8 shows a flow chart an example of a process for determining a service to be provided to the patient;

FIG. 9 shows examples of services to be provided to the patient;

FIG. 10 shows a flow chart of a further example of a process for determining a service to be provided to the patient;

FIG. 11 shows a flow chart of a further embodiment;

FIG. 12 shows an exemplary representation of an electronic patient summary;

FIG. 13 shows a flow chart of a process according to a further aspect of the present invention;

FIG. 14 shows a flow chart of a further aspect using psycho-social data.

### DETAILED DESCRIPTION OF THE INVENTION

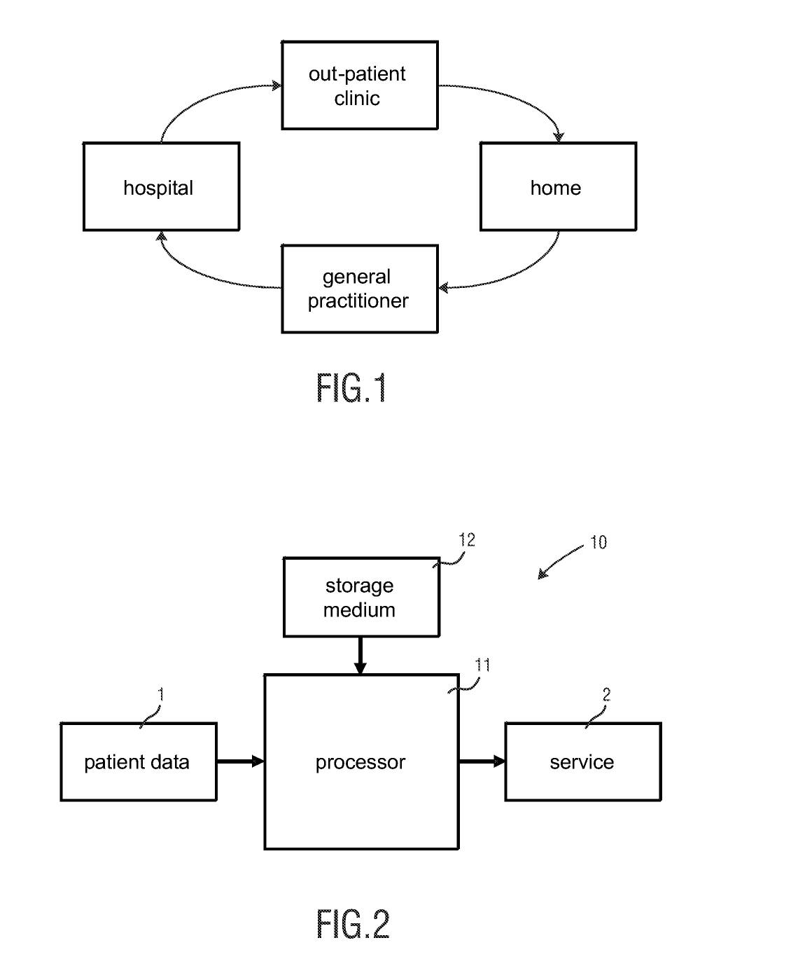

A patient, in particular a patient with a chronic condition, is normally managed across care settings. FIG. 1 illustrates an exemplary journey of a patient through different care settings. In this example, the patient starts his journey at the hospital and is then discharged home under the supervision of an out-patient clinic that takes care of the rehabilitation process. After rehabilitation, the patient takes care of himself at home. Optional additional services, such as telehealth monitoring can be applied at home. Once the patient's condition has deteriorated the patient may consults a general practitioner, who may then decide to send the patient to hospital again. This causes costly re-hospitalizations that could be reduced by optimizing care of the patient throughout this cycle. An early adjustment of a service, for example an adjustment of the medication, may have avoided the re-hospitalization altogether.

To optimize care and to improve clinical outcomes there is a growing body of evidenced, that appropriate services need to be put in place at all stages of the care cycle, including the patient's home. For example, an educational service may help the patient to improve his self-care ability by increasing the patient's education through an education portal. A fall detector can help to detect when sudden events occur.

Further services assist a clinician to detect a deterioration of the patient's condition at an early stage, for example through patient monitoring using a weight scale, blood-pressure meter, or a fluid-accumulation vest. A fluid accumulation vest can help to identify thoracic fluid build-up at an early stage and appropriate countermeasures can be adopted. A ‘service’ as used herein encompasses measures and devices, all with associated hardware and software components.

Today, these services are assigned to the patient in an ad-hoc fashion and may be exclusive for one care setting. For example, a patient is assigned services at home by a home-health agency, which are not necessarily recommended or endorsed by a primary care setting, for example a treating physician at the hospital.

Furthermore, the services should be tailored to the patient's needs for a desired outcome. For example, the patient might be assigned a blood-pressure meter as part of generic advice given to all hypertension or heart-failure patients. The patient is told to measure the blood pressure every day and this requirement would unnecessarily continue even in the case where his blood pressure stabilizes and the risk of health deterioration due to this is significantly decreased. Thus, the service offering is not tailored to the current patient health status and needs.

As a further example, after a few months of using Philips Motiva educational videos, the patient's knowledge level has increased to a sufficient level. However, the confidence in the patient's own ability of doing physical activity may have decreased. In this case an educational service that is more active and provides a coaching component as well might be better for maintaining or improving the patient's health. This requires a self-adapting system.

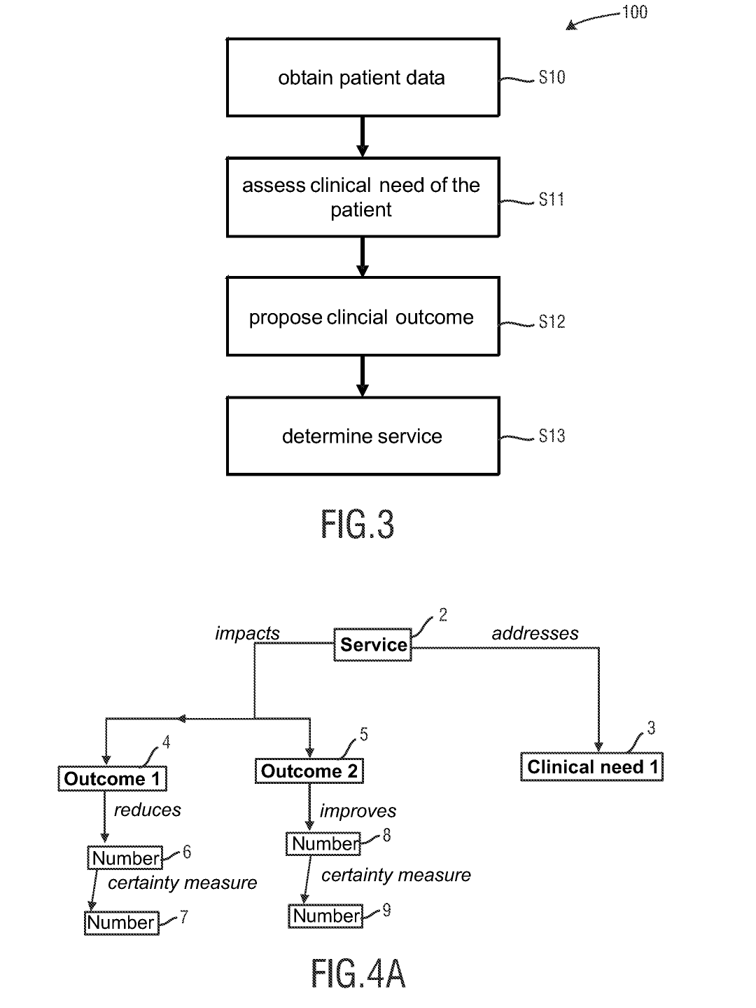

FIG. 2 shows a schematic diagram of a first embodiment of a healthcare support system 10 according to an aspect of the present invention. The system 10 comprises a processor 11 and a computer-readable storage medium 12. The computer-readable storage medium 12 contains instructions for execution by the processor 11. These instructions cause the processor 11 to perform the steps of a healthcare support method 100 as illustrated in the flow chart shown in FIG. 3.

In a first step S10 patient data 1 is obtained. In a second step S11 a clinical need of the patient is assessed. In a third step S12 a clinical outcome is proposed. This proposed clinical outcome can include a target care setting for the patient. For example, that the patient is discharged home or discharged to a nursing facility. In a fourth step, a service 2 to be provided to the patient is determined for said clinical need and said proposed clinical outcome based on the service-outcome-need model. The proposed healthcare support system not only considers the clinical need of the patient but also includes the proposed clinical outcome in the determination of the appropriate service.

For example, a broader variety of services may be available for a patient that is discharged to a nursing home compared to a patient that is discharged home for self-care. Thereby, the services can be optimized across care-settings. Knowing that a patient will be discharged home, a service can already be introduced in hospital so that the patient can get used to the service before relying on this service by himself at home. The proposed system and method helps caregivers to improve the care of chronic patients by providing them support to identify a number of services based on patient's specific needs and furthermore helps to calibrate these services across care setting and through natural progression of patients' condition and co-morbidities to ensure the best care for a particular patient. An advantageous embodiment of the proposed healthcare support system comprises three main elements: A service-outcome-need model, a service database and a clinical needs ontology.

The service-outcome-need model gives a relationship between a particular service (for example a fluid-accumulation vest or education), a clinical outcome (for example readmission or self-care), and a clinical need it addresses (for example thoracic fluid build-up or knowledge).

The service database comprises an instance of the service-outcome-need model for each service. The model for each service can be obtained via a data analysis of a historical patient population. Furthermore patient classes are associated with each service. For example, an instance of the service-outcome-need model is set up for the service ‘fluid accumulation vest’. The service-outcome-need model describes that, for a particular class of patients, the service fluid accumulation vest positively affects readmissions by providing information about the thoracic volume.

A clinical needs ontology gives a relationship of the clinical needs for a particular clinical domain or disease. A clinical ontology indicates, for example, that weight changes could also adversely influence blood pressure.

The following will describe two steps for providing a basis for the healthcare support system. A first step comprises analyzing data for each of the services on a patient population level. A second step comprises analyzing a domain model to obtain a relevant ontology for the clinical needs. An example of a domain model is the combination of standardized medical knowledge, such as represented in SNOMED, and information in a same or similar format as defined for the local situation. These relations can be particular to the care offerings and quality standards of the local care system/hospital. Thus, the domain model can serve for adaption to one or more local care settings.

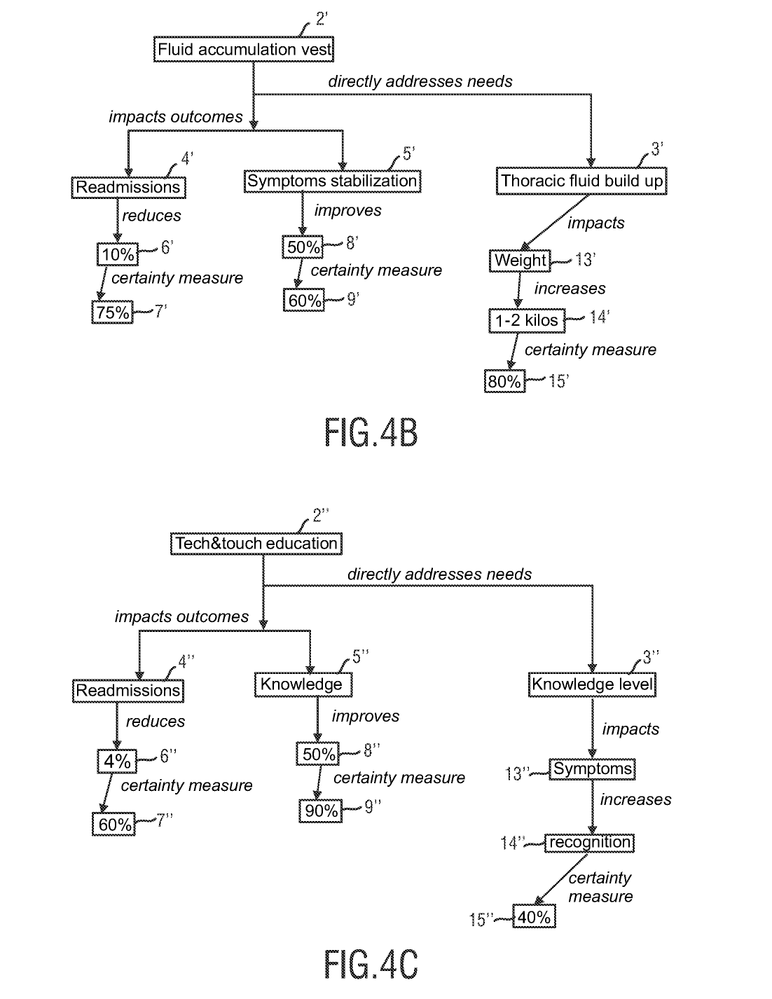

In a first aspect of the first step, a service database can be created based on patient population data. For each service, an instance of the service-outcome-need model is created. An example of how the service-outcome-need model could be represented is shown in FIG. 4A. The service 2 addresses a first clinical need 3. Furthermore, the service 2 impacts a first outcome 4 and a second outcome 5. In the shown example, the first outcome 4 reduces an item 6 with a certainty measure given by item 7. Correspondingly, the second outcome 5 improves an item 8 with a certainty measure given by item 9.

FIG. 4B shows an instance of the service-outcome-need model for the exemplary service ‘fluid accumulation vest’. For example, the patient has problems with thoracic fluid build-up 3′. The fluid accumulation vest 2′ directly addresses this clinical need. The thoracic fluid build-up 3′ impacts the weight 13′ of the patient. The weight 13′ increases about 1 to 2 kilos 14′ with the certainty of 80% 15′. The fluid accumulation vest 2′ as a service provided to the patient has impact on the readmissions 4′ as the first outcome and further impacts the symptoms stabilization 5′ as the second outcome. Readmissions 4′ in this example reduce by 10% 6′ with a certainty measure of 75% 7′. The symptoms stabilization 5′ as the second outcome improves by 50% 8′ with a certainty measure of 60% 9′.

FIG. 4C illustrates a further instance of the service-outcome-need model of FIG. 4A. This example relates to tech & touch education 2″ as the service 2. The tech & touch education 2″ directly addresses the clinical need ‘knowledge level’ 3″ of the patient which in turn impacts the symptoms 13″ by increasing the recognition 14″ with a certainty measure of 40% 15″. The tech & touch education 2″ impacts the outcome ‘readmissions’ 4″ as described with reference to the example given in FIG. 4B. Furthermore, the second outcome ‘knowledge’ 5″ improves by 50% 8″ with a certainty measure of 90% 9″. The knowledge of the patient can be assessed, for example, with a questionnaire.

Referring back to the service-data base, an instance for the service-outcome-need-model can be created as follows:

i. Collect data sources that are used in clinical studies and/or measurement data from a patient monitor or from a database including an electronic health record of a plurality of patients.

ii. Using data analysis techniques, mine the data to obtain the key outcomes that the service is able to influence. Thereby, a service-outcome model can be populated, where for each service and outcome there is an indication of the percentage a service increases or decreases an outcome and a certainty of the outcome, as illustrated in FIGS. 4A to 4C.

iii. This service-outcome model is enriched with the clinical needs addressed by the service, thereby creating the service-outcome-need model. According to an aspect of the invention, this enrichment of the service-outcome model with the clinical needs addressed by the service is not only based on data analysis of existing patient population data but is further based on clinical knowledge, in particular clinical knowledge from experts and clinical knowledge gathered from medical journals.

A second aspect of the first step relates to creating patient classes that correspond to certain services. Patient classes can for example be created via data analysis. For this purpose, historic patient data can be used. Patient data for each patient encompasses at least one of clinical characteristics (for example blood pressure, weight, fluid status), social and demographic parameters (for example social characteristics, admission details, medical history, length of stay in hospital), and parameters that describe a service-usage (for example number of days of usage after enrollment to a service, number of interactions with caregivers during service usage and other administrative data such as insurance details). However, patient data is not limited in this respect.

The creation of patient classes can further involve subdividing patients into groups, referred to as classes, where within a class patients respond similar to a service or set of services. Alternatively or in addition, there are differences in the response of patients of different classes to a service or set of services. The creation of classes can be performed by machine-learning techniques. For example, clustering can be performed fully unsupervised by machine-learning techniques. Alternatively, according to an aspect of the present invention, the classification is at least assisted by input from and/or validation by a clinical expert. The output is a grouping, i.e., a classification, of patients. Each class of patients can be characterized in terms of the parameters used to describe the patients, i.e. clinical parameters, social condition, administrative data and the like, for example by taking the mean or medium value from all patients in a group. Furthermore, an uncertainty of the classification can be given by statistic parameters such as the standard deviation.

Further to the subdivision of patients to classes, also the composite success rates of services per patient class can be calculated. Each service for the patient class can be associated with outcomes. Optionally, also the period of time the outcome is achieved and/or patient perceived satisfaction and/or compliance to usage of the service are determined. Service-usage data of all patients in this patient class can be combined into a single measure for success for the service for patients in this class.

Furthermore, the composite patient characteristics of the patient class can be compared to general targets, which in turn can be compared to clinical outcomes of a given service. For example, the systolic blood pressure is known to have a proper value around 120 mm Hg, the class average might be 150 mm Hg and a coaching service for physical activity is able to reduce this value by 20%. From this information, one can conclude that this particular service is in principle able to successfully guide patients belonging to this patient class to healthy blood pressure values.

Alternatively, these two different types of success measures can be combined into a single measure, for example by taking a weighted average, which allows for the creation of an ordered list of services per patient class based upon their success rate.

FIG. 5 illustrates the collection of service-outcome-need models and patient classes into a common services database 20. For each service 21, 22, 23, the aforementioned instance of the service-outcome-need model 24 is created. Furthermore, a patient population from a patient-population database 25 is analyzed 26 to create a plurality of patient classes 27. These operations are also performed for the further services 22, 23. The results are collected in the services database 20. In the step of determining the service to be provided to the patient for the clinical need and the proposed clinical outcome, S13 in FIG. 3, this services database 20 can be accessed.

Referring now to the second step for providing a basis for the healthcare support system, a further aspect of the present disclosure relates to the creation of a domain model of the clinical needs. Based on the disease in question an ontology that relates clinical needs can be built. Advantageously, the ontology is built with input of at least one of a clinical professional or data from medical journals. Furthermore, also for comorbidities, such as diabetes and heart failure, an ontology may be used to model clinical needs. The domain model can encompass the selection of the right ontology or multiple ontologies or parts of ontologies that are of importance to the patient, given his disease and care setting, for example home or hospital.

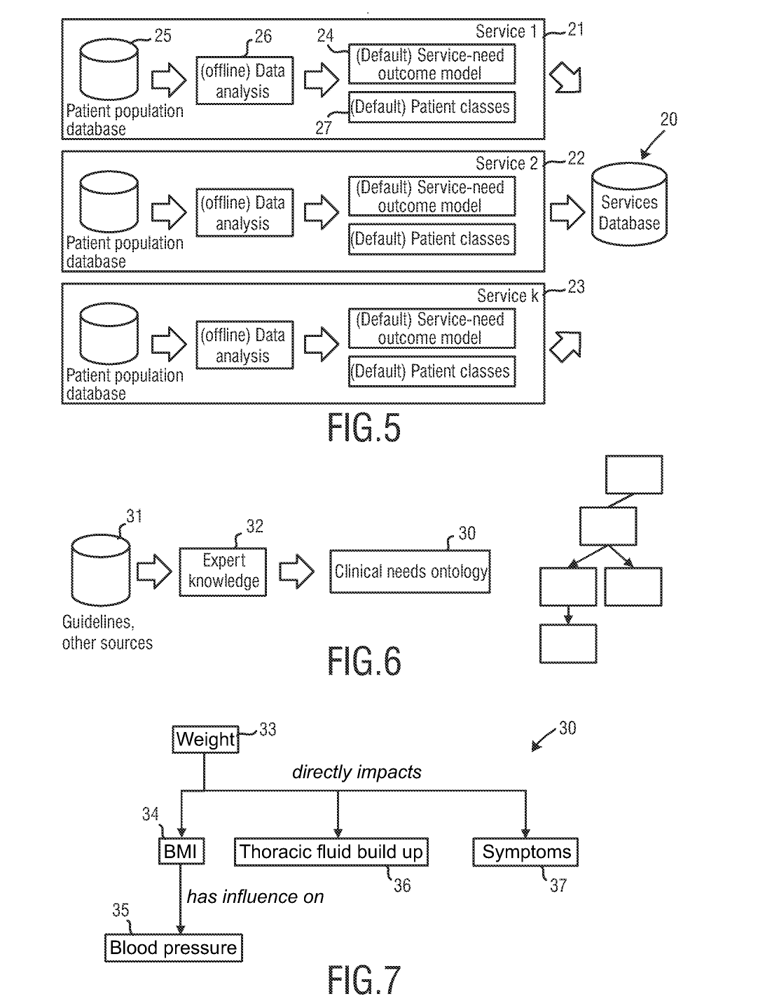

FIG. 6 illustrates the creation of a clinical needs ontology 30. Based on guidelines and other sources 31, in particular structured sources like medical journals, and expert knowledge 32 the clinical needs ontology 30 is established which then relates clinical needs to one another. Alternatively, the sequence of elements 31 and 32 is changed or they are used in parallel.

FIG. 7 illustrates an example of a clinical-needs ontology 30 that gives a relationship of clinical needs for a heart-failure patient. In this example, the clinical-need weight 33 directly impacts the clinical needs body mass index (BMI) 34 which in turn has an influence on the clinical need blood pressure 35. Furthermore, the weight 33 directly impacts thoracic fluid built-up 36 and further symptoms 37. A clinical needs ontology 30 is not limited in this respect but could also be a mesh-like structure with multiple dependencies.

The use of ontologies in addition to purely relying on existing patient population data is particularly advantageous in cases where no data is available that would reveal relations between outcomes and services. For example a service can be new to the world or new to the hospital. For such cases, it is beneficial to use additional knowledge sources such as ontologies that provide or at least help to derive the connection between outcome and service.

Advantageously, a combination of three strategies is used to infer an anticipated outcome for a given service. Firstly, patient-population data can be analyzed by applying data mining techniques. The patient population can be local, regional, country-wide or even global. Secondly, information from structured sources, such as an ontology, can be used that describe patient characteristics, service interventions and outcomes. Thirdly, evidence extracted from medical journals can be used, where patient characteristics, service interventions and outcomes are extracted using natural language processing techniques. If there is conflicting evidence between any of these sources, a hierarchy can be established. Local evidence, i.e. evidence from a patient population, in particular a local patient population prevails over broader evidence using structured sources. Furthermore, evidence gained using patient population data prevails over evidence from structured sources, which in turn prevails over evidence extracted from medical journals.

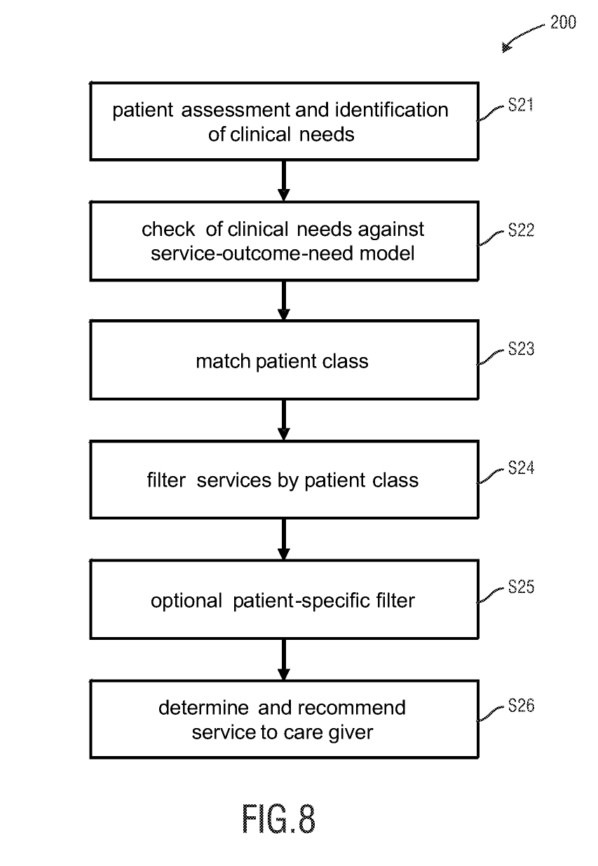

FIG. 8 illustrates a further embodiment of the present disclosure. When the patient is first hospitalized and/or diagnosed the initial service determination or matching for the patient can comprise the following steps shown in the flow chart 200.

In a first step S21, a caregiver assesses the patient in a traditional fashion and thereby identifies clinical needs of the patient. This step can be further assisted by the healthcare support system which obtains patient data of the current patient and assesses a clinical need of the patient based upon patient data and input from a caregiver or a patient himself.

In a second step S22, these clinical needs are checked against instances of the service-outcome-need model top to bottom, and thereby identify which services would fulfill the clinical needs of the patient. Instances of the service-outcome-need model are provided by the services database.

In step S23, the obtained patient data which includes patient characteristics, is used to find the best matching patient class. For example, this matching can be based upon a distance or dissimilarity measure to compare the patient characteristics with the characteristics of the patient classes.

In step S24, the ordered list of services for the selected patient class is taken and filtered for services that have been identified in step S22. Step S24 thereby provides an ordered list of services that could be suitable for this patient. For example, the best service is the one on top.

An optional patient-specific filter is applied in step S25. Under the condition that historic information on services that have previously been used by this particular patient is available, the ordered list can be further filtered, for example, by filtering out service that did not work or did not have the desired impact on this particular patient. A further or alternative additional filter could filter out services that would be over budget, taking into account the financial situation and insurance of the patient, or services that are simply not available across different care settings. For example, instead of selecting a service that is special for the current care facility, an alternative service can be preferred that is available throughout the entire care cycle.

In the last step S26, the determined services to be provided to the patient are recommended to the caregiver to provide to the patient.

For example, the patient's key needs are to stabilize the thoracic volume overload and to increase his knowledge. In this case, the fluid accumulation vest and the tech & touch educational DVD could be recommended to the caregiver to offer to the patient. If it turns out that this patient fits well into a patient class for which the fluid accumulation vest generally has more effect, i.e., a higher success rate in addressing the volume overload need, the service ‘fluid accumulation vest’ can be determined as the best matching service to be provided. For a different patient, the tech & touch educational DVD could be the preferred choice.

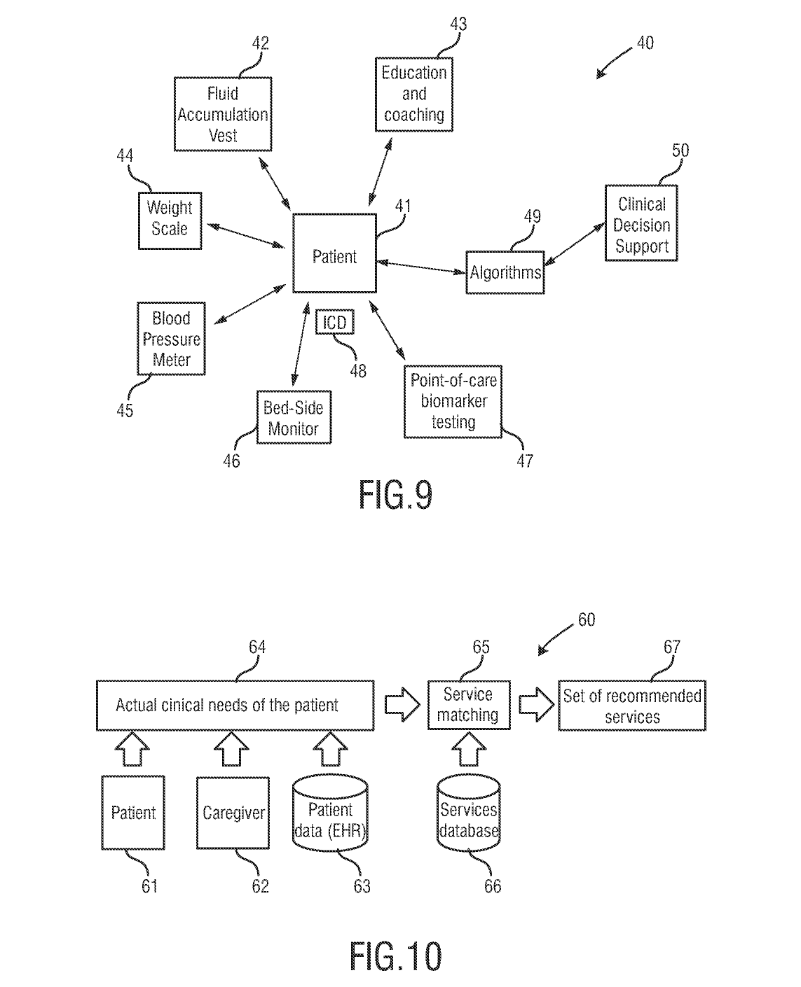

When the patient is at home, he will use the determined services. FIG. 9 shows an example of a set of services 40 that are provided to the patient 41. In this example, the set of services 40 comprises a fluid accumulation vest 42, education and coaching material 43, a weight scale 44, a blood-pressure meter 45, a bedside monitor 46 and a point of care biomarker testing device 47 as well as an implantable cardioverter-defibrilator (ICD) 48. Measurement data from one or more of these devices can be available for analysis using an automated program with algorithms 49 and can also form the basis for further clinical decision support 50. For the case of educational material, knowledge of the patient can be measured by the quality of his answers.

FIG. 10 further illustrates the process 60 of determining services to be provided to the patient for the example of a newly diagnosed patient. In this example, patient data is obtained by input from the patient 61, an examination by the caregiver 62 and using patient data 63 obtained from an electronic health record (EHR). Based on this information, the healthcare support system assesses the actual clinical needs of the patient 64. The service matching 65 comprises the steps of proposing a clinical outcome, for example lowering the blood pressure, such that the patient can be discharged from hospital for self-care at home and determining the corresponding service to be provided to the patient for said clinical need and said proposed clinical outcome based on the service-outcome-need model. For this purpose, the service matching 65 has access to the services database 66. The output of this process is a set of recommended services. These services determined by the healthcare support system can be provided as recommendations to the caregiver 62 and the patient 61.

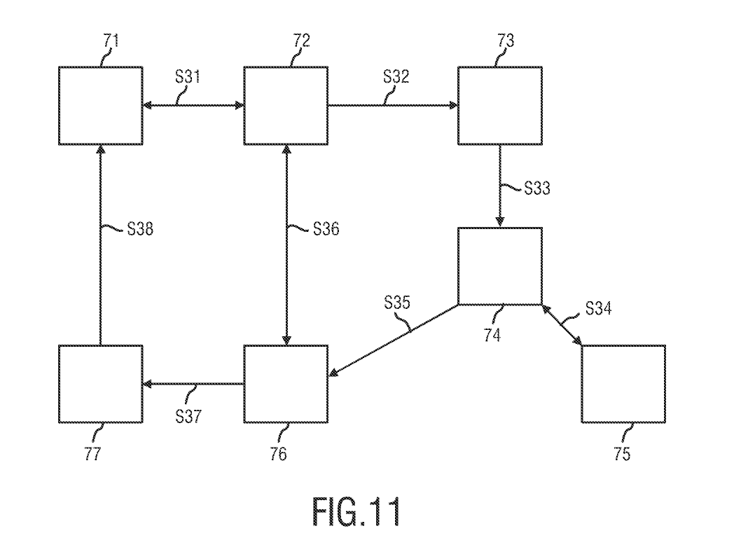

FIG. 11 illustrates a further aspect of the present disclosure. Four components that can be highlighted are a patient summary 72, a home health service delivery selection for determining services to be provided to the patient in a stratification module 73, an at-home monitoring using said services 74 and adjustment and finally an update patient summary 72.

Firstly, a doctor 71 views the patient summary 72 and configures the electronic patient summary (SUEP) 72 to the most relevant data items in step S31.

In step S32, when the patient's condition has improved and it is decided that the patient can be discharged, the stratification module 73 is triggered. Hence, in this embodiment, the healthcare support method described above for determining care for a patient can be executed upon patient discharge.

In the embodiment shown in FIG. 11, the stratification module 73 also analyzes the patient summary configuration 72. Hence, patient data is obtained based on elements selected for the patient summary 72. The determination of the service to be provided to the patient is thus based on elements selected for the patient summary 72. Based on the information that is configured to show in the summary 72, the stratification module 73 recommends which services 74, including any necessary devices, may be provided to the patient in step S33 for home care and monitoring. For example, if the patient summary 72 is configured to show blood pressure, it is likely that blood pressure is an important factor in monitoring the patient, so a blood pressure cuff should be included in the determination of services.

In step S34, the patient 75 at home uses the provided home services 74 as requested by the caregiver.

Advantageously, in step S35, measurements from the home monitoring services 74 are stored in a hospital database 76.

If the doctor 71 views the patient summary 72, measurements from the patient's home monitoring devices as services 74 can be included S36 in the view. Also, if needed, the patient summary 72 is adapted to include further information that may now be relevant. For example, a monitored vital sign is out of a healthy range, only once or a number of times or for a predetermined period. Correspondingly, it may also be the case that previous information is now irrelevant, in which case the summary 72 configured to exclude this information. As a consequence, the services 74 can be adapted accordingly.

In specific cases, measurements at the patient's home may give rise to a situation in which the doctor 71 should have a look at the data to assess the patient's health. Optionally, an alerting service 77 analyzes S37 the incoming home measurements, optionally combined with the patient summary 72 configuration. When necessary, the alerting service 77 will alert the doctor 71 to have a look at the patient summary 72 in step S38.

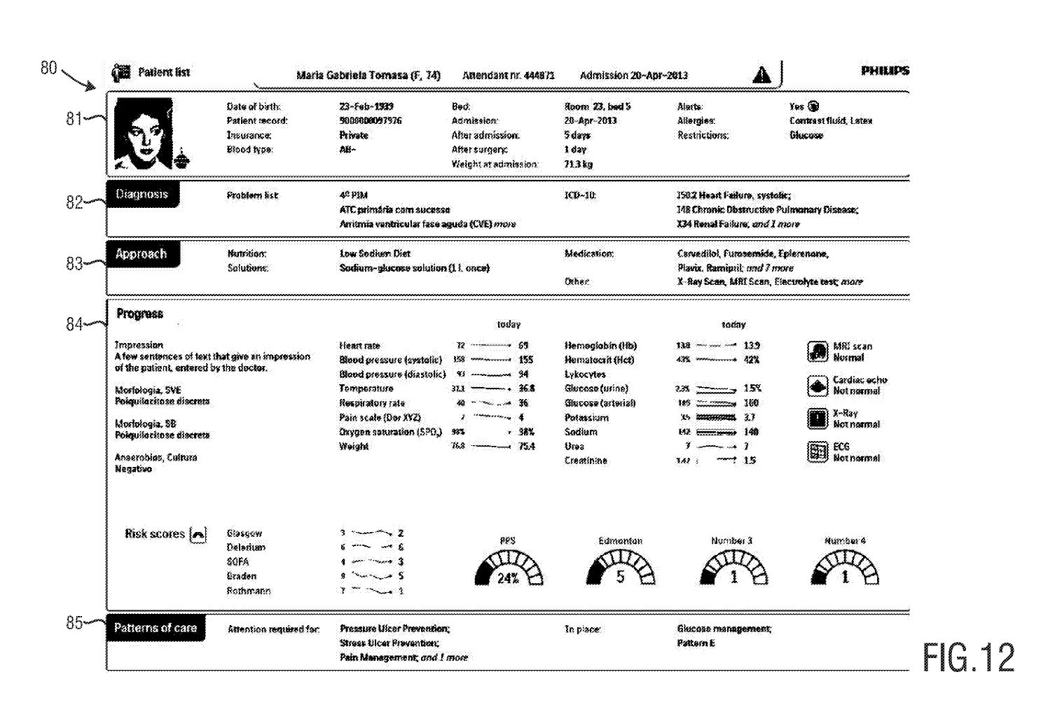

FIG. 12 shows an exemplary representation of an electronic patient summary (SUEP). In an embodiment, the SUEP is the main page 80 to manage patients. It provides an easy to experience, preferably single page overview of the patient. For example the SUEP comprises one or more of administration information 81, patient diagnosis 82, care approach 83, progression 84 and the quality matrix applicable to this patient.

The patient summary 72 can be constructed in different manners or combinations thereof. Firstly a patient specific configuration is based on a diagnoses of the patient, relevant information on treatment, laboratory values, vital signs and medical history. Secondly a specific to point of care configuration is based on the care settings such as general ward, ICU, post-surgery recovery and the like. Elements of the patient summary are displayed that are typical for the associated care setting. Thirdly, a hospital specific configuration is based on the hospital's quality initiatives and performance indicators based on which elements are included in or added to the patient summary. These elements can be measurable actions that improve patient care and outcome, such as providing discharge instructions, offering smoke cessation classes or managing the patient to prevent pressure ulcers. As a fourth example, there can be a clinician specific configuration wherein, based on the clinical assessment of the patient, the clinician can select or deselect elements from the patient's electronic medical record to be displayed in the patient summary. This mechanism allows for further tailoring towards the status of the patient. This is especially important for multi-morbid patients, where it may be unclear which disease causes the most important and acute medical problems. Referring again to FIG. 11, a fifth way to construct the electronic patient summary can be based on data received from services 74 provided to the patient, for example from a patient monitor in a home care setting.

The home health service delivery selection of the stratification module 73 is configured for determining services to be provided to the patient. When triggered, this component computes obtains patient data, assesses a clinical need of the patient, proposes a clinical outcome and determines a service to be provided to the patient for said clinical need and said proposed clinical outcome. A first input for patient data can be the patient's electronic patient summary 72 comprising all selected data fields and their values. If multiple clinicians have created their own electronic patient summary for the patient it is possible to take a combination or selection thereof. A second input for the possible services to be provided to the patient is a database with possible offerings. For example, the database of services includes sensor-based home monitoring solutions, educational material, home nurse visits, questionnaires and other services, in particular home care services.

In an embodiment, a determination of service offerings for a patient is based on his electronic patient summary (SUEP) 72 or multiple SUEPs. Firstly, set of rules can be implemented describing relations between parameters present in the SUEP or values of such parameters. For example, if “glucose” is in the SUEP then a glucose monitor is determined as a service to be provided to the patient. Alternatively, if “glucose” has values outside normal ranges or insulin is administered, then a glucose monitor is determined as a service to be provided to the patient.

Alternatively, the service or service arrangement can be determined based on observed arrangements for patients in a historic collection of patient SUEP and service selections. For example, a combination of SUEPs of the patient is compared with the historic database to identify the similar cases. Subsequently, the recommended services for the patient are based on services selected for similar peers.

According to a further aspect, during the usage of services 74, in particular home health services, both their usage and arrangement can be tracked. For example, this can include a subscription and usage of new home health services or elements, for example a new educational module, new engagement with specialist care, attendance of an online quit smoking course, monitoring of a different vital sign or biomarker. Correspondingly, a discontinuation of said services or elements of said services can be tracked. Furthermore, out of normal range values for measured values such as symptoms, signs or biomarkers can be tracked.

According to a further aspect, the electronic patient summary (SUEP) 72 can be updated. Advantageously, the SUEP or SUEPs of the patient are updated automatically based on the aforementioned tracking of the services provided to the patient or data obtained from said services. For example, parameter values that are (often) out of normal range can be added to the SUEP. Alternatively or in addition, parameter values that return to normal values can be removed or made less prominent.

In an embodiment for changes in service offerings, a reverse algorithm can be applied as above referring to home health service delivery selection of the stratification module 73. Hence, for a known patient status in combination with updated service offerings, it can be observed which SUEPs are applied on past patients in a database. For example, it can be observed that when introducing a nebulizer, the lung function values are of increased importance when treating the patient. In other words, elements can be selected for the SUEP which were considered important for previous patients. Hence, an evidence-based selection is provided.

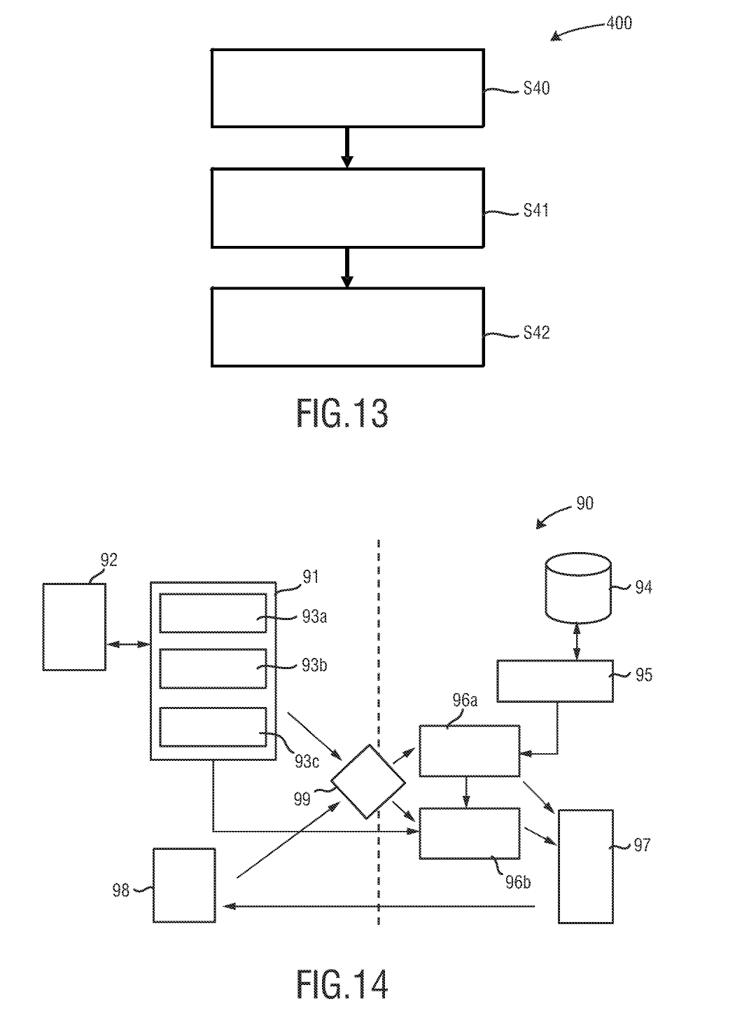

A further aspect of the present disclosure will be described in more detail with reference to FIGS. 13 and 14. Here, the instructions cause a processor 11 of a healthcare support system as shown in FIG. 2 to perform the steps of a healthcare support method 400 as illustrated in the flow chart shown in FIG. 13.

In a first step S40 patient data is obtained, wherein the patient data comprises psycho-social data. In a second step S41 a clinical need of the patient is assessed. In a third step S42, a service to be provided to the patient for said clinical need is determined and it is further determined how the service is to be provided to the patient based on the psycho-social data.

This aspect of the present disclosure can advantageously be applied in the method described with reference to the flow chart of FIG. 3. Correspondingly, in a first step of obtaining patient S10, the patient data comprises psycho-social data. In the fourth step S13, the service 2 to be provided to the patient is determined for said clinical need and said proposed clinical outcome based on the service-outcome-need model and is further determined how the service is to be provided to the patient based on the psycho-social data.

The determination what service is to be provided to the patient and how the service is to be provided to the patient follows a three-stage process analogous to the sequence of steps S40, S41, S42 illustrated with reference to FIG. 13. On an abstract level, an aspect of the envisioned system utilizes patient data to compute a cost and/or risk profile of a patient. These profiles can be used to compute care needs for determining what services to provide based on the clinical condition of the patient. Advantageously, the care needs take into consideration the current living circumstances. The step of determining what service is to be provided can be followed by a subsequent psycho-social profiling for determining how this service is advantageously provided to the patient. Both of steps are preceded by a step of obtaining patient data, wherein the patient data comprises psycho-social data.

Advantageously, there can be an update procedure after deployment of the service, wherein the service to be provided to the patient and/or how the service is to be provided to the patient are updated. For example, it is assessed whether a revision of the delivery of a current service is required and/or if a new arrangement of service or services should be proposed.

An advantageous embodiment of a healthcare support system 90 for determining a service and service delivery is described in more detail with reference to FIG. 14.

A storage 91 for psycho-social data is provided. An interface 92 can be provided to obtain said psycho-social data. Different ways of obtaining psycho-social data will be described further below. The psycho-social data 91 can comprise one or more of a communication profile 93a, a psychological profile 93b and a social profile 93c, which will now be explained in more detail.

Referring to the communication profile 93a, the success of the delivery of any healthcare service such as a clinic visit, education, home nursing or palliative care, strongly depend on an appropriate communication means and an appropriate communication style chosen by the caregiver such as a healthcare professional. This communication style can be adjusted depending on a number of factors such as health literacy, educational level, attitude towards self-care and their disease, cognitive functioning, and ability to work with technology. In an embodiment, a score between 0 and 1 is derived for one or more of such factors. Optionally, the assessment of one or more communication profile factors is done redundantly, for example three-fold. According to a first aspect, an exemplary assessment of relevant communication profile factors can be done explicitly by questionnaires. The patient can be offered a questionnaire, where elements of the communication profile factors are assessed. Based on the responses, a score can be derived for one or more factors. A second explicit assessment can be performed by a person such as a clinician or a nurse. In this case, communication style factors can be manually rated by a professional treating the patient, for example a nurse. Thirdly, communication profile factors can be assessed implicitly by observing behavior. Some or more of the communication style factors can be derived by analyzing the behavior of the patient, for example the ability to work with technology. For the case that two or more scores for a specific factor are known, a weighted average can be taken. Advantageously, the communication style factors are updated regularly. For example, health literacy may increase during extended hospitalization.

Referring to the psychological profile 93b, psychological aspects, such as attitude, self-perception, coping with disease, willingness to change lifestyle and adherence to therapy can be vital aspects for successful therapy at option. When providing a certain service, knowledge on one or more of these and other psychological aspects can be essential to come to a strategy on how to approach the patient. Psychological factors can be assessed in a similar way as being done in the communication style profile described with reference to element 93a. Likewise, if multiple scores are available, a weighted average can be taken.

Referring to the social profile 93c, an understanding of a social situation of the patient can be a vital aspect to tailor the delivery of care, i.e., how a service is to be provided to the patient. For example, the social situation includes the living condition and informal caregivers such as spouse, children, neighbors and friends involved. In order to optimize care delivery, it is important to profile under what conditions the patient lives and who is there to help them. With respect to the latter, the nature of the care offered as well as the caregivers' attitude towards the patient and disease are of importance. Again, profiling can be done through several exemplary mechanisms, some of which are explained in the following. Firstly, profiling can be done explicitly by questionnaires to the patient. The patient can be offered a questionnaire where aspects such as living conditions, care needs and informal caregivers are assessed. Based on the responses, a score can be derived. Secondly, profiling can be done explicitly by questionnaires for the informal caregivers. For example, when is known who is providing informal care to the patient, these individuals can be offered questionnaires assessing factors regarding the nature of their involvement, knowledge on required self-care behaviors of the patient and their attitude towards the patient and the care offered. Thirdly, profiling can be done explicitly by questionnaires for the formal caregivers. For example, similar questionnaires can be offered to the formal caregivers, where they can report an impression about the patient's living arrangement and the care that he is receiving, in particular care from informal caregivers at home. Furthermore, profiling can be done implicitly by observing behavior. For example, one or more sensors can be used, in particular at the patient's home. Thereby it can be observed who is providing healthcare with particular care needs such as washing, taking medication and the like. Hence, for some aspects, a social assessment factor can be measured through sensor-based technology. Once again, the factors in assessing a patient's social profile can be computed by taking a weighted average of one or more contributors such as the afore-mentioned exemplary mechanisms of assessing a patient's social profile.

A further source of patient data can be an electronic medical record (EMR) 94 of the patient. Advantageously, access to the patient's medical record data is available, for example including a medical history, medical claims data, information about current and past diseases. Moreover, measured data can be made available in the electronic medical record, for example vital signs, laboratory results and/or imaging data. This data can be used in an evidence-based determination of a patient's risk and/or financial or cost profiles.

In the embodiment shown in FIG. 14, a combination of cost and risk profiles 95 is used. Regarding the cost profile, an estimate of the healthcare costs can be computed, for example split out into different categories such as hospitalizations, home services, medication and/or clinical consults. For example, these projected healthcare costs can be determined using data mining techniques for an upcoming period of for example the next 365 days. This can exemplarily be done in three phases. In a first phase, the patient P's data can be compared with a historic set of patients, wherein the data does not only comprise the data from the EMR, but advantageously also psycho-social data. A corresponding link between the storage of psycho-social data 91 and element 95 can be established. A set of patients similar to patient P at some time T of measurement can be identified. Secondly, using this set of similar patients, for one or more categories, future utilizations of services can be estimated for the patient P, by analyzing the healthcare utilizations of the peer group of similar patients after times T. Thirdly, a look-up table with current healthcare costs can be used to map the projected healthcare utilizations to financial costs.

Reference is now made to the risk profile of the combination of cost and risk profile 95. In an embodiment of the risk profile, for the patient the risk of an early adverse event such as mortality or readmission is determined based on the patient's clinical data and optionally on non-clinical data. The patient data can be based on the EMR 94 and optionally also factors in psycho-social data 91. For example, the determination can be done using one or more risk models known from literature to determine a score from 0 to 1. For example a model for determining a score expressing the risk of an early event can be used.

Alternatively or in addition, a data mining approach can be used, wherein a historic set of patients is compared with the clinical and/or psycho-social data of patient P. Based on this data, a perspective of patient P can be determined by observing the perspective of patients similar to patient P. The result can be expressed using a score for example from 0 to 1. Again, various approaches can be weighted and combined to determine a risk profile of the patient.

According to the embodiment described with reference to FIG. 14, the selection of a service need 96a, i.e., what service is to be provided to the patient, and a selection of a service delivery 96b, i.e., how the service is to be delivered to a particular patient are performed consecutively. However, in the alternative, a combined determination, can be performed. Advantageously, a clinical outcome is proposed and a service to be provided to the patient is determined for a clinical need and a proposed clinical outcome based on the service-outcome-need model.

Referring again to the selection of a service need 96a, the cost and/or risk profile as well as a clinical status of the patient can be combined to determine an optimized selection of services for the patient. According to a first exemplary strategy for selecting or determining a service need, a protocol is defined that combines one or more of risk, financial profile and clinical status into a recommendation for one or more services. Each service can be associated with the patient profile comprising aspects for these categories. For example, a NYHA (New York Heart Association Functional Classification) class III patient with a readmission risk larger than 0.6 can be recommended a telehealth solution, while a respiratory patient with GOLD (Global Strategy for the Diagnosis, Management and Prevention of Chronic Obstructive Pulmonary Disease) class II or larger and optionally a financial profile of costly hospitalizations may receive oxygen therapy. Alternatively, or in addition, a data-mining based way for determining a service need can be used. In a similar fashion as described above, using the profiles of historic patients, it can be observed which services were recommended to a patient with a similar condition. An output of the step of selecting a service need can be a list of recommended services, which can be provided to the next step 96b for selecting service delivery.

Referring to the selection of service delivery 96b, each service can be associated with a number of different delivery options, i.e., different options of how to provide a service to the patient. In an embodiment it can be distinguished between two different categories, delivery profiles and delivery alerts. A delivery profile can reflect a nature of the delivery of a service, for example a tone of voice, a level of detail, a frequency or length of contact, characteristics of the individuals, and other aspects involved in the communication with the patient and/or their informal carer. In an embodiment, the delivery profiles can be communication scripts or a protocol for a human caregiver or technology settings that affect a communication style or content. Although such profiles may be updated, for example when an attitude, knowledge or clinical condition changes, they are advantageously applied for a longer period of time.

A delivery alert can reflect suggestions on an immediate delivery of an aspect of a service within a delivery profile. For example, a home nursing agency can be triggered to contact the patient by phone while taking into account the patient's resistance to medication therapy adherence. Hence, the delivery alerts can be part of an existing service and take into account the delivery profile suited to the patient's needs.

Advantageously, a delivery profile is determined per recommended service. Given a range of delivery profiles, the profile can be selected that best suits the patient. The determination can be done using a knowledge-based approach, similar to the protocol described in selecting the services and/or using data-mining techniques. For determining delivery profiles the communication profile 93a, the psychological profile 93b and/or the social profile 93c can be used.

Advantageously, delivery alerts are generated using patient data monitored in a home setting. When evidence arises that the patient is deteriorating, for example using a knowledge-based or data mining technique, then a delivery alert can be triggered using techniques known in the field. A script can be provided for interaction with the patient based on a current delivery profile.

When it has been determined what service is to be provided to the patient in step 96a and how the service is to be provided to the patient in step 96b, the service can be deployed in step 98. Advantageously, the one or more services will be arranged for the patient after an optional review 97 by a responsible professional. Services and service delivery as determined by the healthcare support system 90 can be seen as a recommendation or decision support to the professional, wherein the actual decision is left to the professional's discretion. The professional can review and select services as well as delivery settings. When applicable, a delivery setting for a technology can be selected. An example is the selection of educational videos with the right tone of voice.

Optionally, the healthcare support system can be configured to implement an update functionality 99. For example the patient can be tracked over time using services deployed at home. Measured physiological data can be used in combination with the patient's psycho-social data 91 in the update component 99. Therein, a decision can be made to update one or both of the service arrangement of the patient in 96a and the delivery profile of the patient in 96b. Optionally, there can be a trigger for this update, for example a change in the patient's profile, for example including his clinical status, psychological status, change in risk and/or change in cost perspective. Alternatively, or in addition, frequent deteriorations of the condition as measured for example using home monitoring devices can be used which implying that the current services or delivery of services may be sub-optimal. Advantageously, measured and/or reported data can be combined with the patient's psycho-social data 91 to determine this decision. Once again, the decision can either be determined using a knowledge-based approach and/or through data-mining techniques.

Referring again to FIG. 14, items depicted to the right of the vertical dashed line may be implemented at a care giver whereas items depicted to the left of the vertical dashed line may be implemented for example at the patient's home. Alternatively, some or all of the items may be implemented for example at a care giver, at the patient's home, in cloud-based or mobile solutions.

In clinical practice, specialist physicians and nurses often have a limited scope on the patient and corresponding treatment responsibilities. They can be focused on their field of expertise. For example, a senior cardiologist will mainly worry about pharmaceutical treatment of the patient's heart condition and leave the treatment of co-morbidities to his colleague specialist (e.g. the rheumatologist, a COPD expert etc.). Nursing staff is skilled in the selection of services specific to their particular medical specialism. The disclosed healthcare support system and method will help such nurses, the intended main user, to draft an evidence-based care plan beyond their specialism.

Optionally, the clinical needs of the patient can be re-assessed and the services re-calibrated on a recurring, for example daily basis. For example, if the patient knowledge has increased to the level that satisfies the outcomes, then the system could recommend to the caregiver to remove the service from the patient's home or to otherwise discontinue the service. Thereby, superfluous services can be eliminated and a treatment cost can be reduced.

Furthermore, if this healthcare support system learns and gains new insights in the success of services that address the needs of a patient, and finds out that the patient would benefit more from a different service other than the one he currently uses, the system could provide a recommendation to the caregiver to change the service for this patient.

Moreover, based on the clinical needs ontology, the system can do the matching between the current patient clinical needs and the potential needs that might be impacted in view of the given assessment of the current needs. For example, if the ontology gives a direct relationship between the weight and further symptoms, then the symptoms are the potential need that might be impacted and the system would use that information to match it with patient data on the symptoms or suggest to the caregiver to re-assess the symptoms in the next visit in order to re-adjust the services for the best outcome.

In general, this invention is applicable to any clinical domain in which patients need to be followed across healthcare settings. The automated assignment of services to patients is of particular relevance to home-health solutions. Furthermore, in-hospital solutions of cardiology informatics such as the Intellispace Cardiovascular of the applicant can also benefit from this invention by incorporating the determination of a service into their clinical module features.

In conclusion, the elements of the present disclosure help to identify the most appropriate services for the patient based on his health status and desired outcomes and to automatically, based on the current patient health status, suggest adjustments of the services from the service database. In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible device or apparatus that can contain, store, communicate, propagate, or transport the program for use by or in connection with the instruction execution device.

In so far as embodiments of the disclosure have been described as being implemented, at least in part, by software-controlled data processing devices, it will be appreciated that the non-transitory machine-readable medium carrying such software, such as an optical disk, a magnetic disk, semiconductor memory or the like, is also considered to represent an embodiment of the present disclosure.

Further, a computer usable or computer readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example, without limitation, physical or wireless.

A data processing system or device suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories, which provide temporary storage of at least some computer readable or computer usable program code to reduce the number of times code may be retrieved from bulk storage during execution of the code.

Input/output, or I/O devices, can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems, remote printers, or storage devices through intervening private or public networks. Non-limiting examples are modems and network adapters and are just a few of the currently available types of communications adapters.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated. Other variations to the disclosed embodiments can be understood and effected by those skilled in the art in practicing the claimed invention, from a study of the drawings, the disclosure, and the appended claims.

1. A healthcare support system for determining care for a patient, the system comprising a processor and a computer-readable storage medium, wherein the computer-readable storage medium contains instructions for execution by the processor, wherein the instructions cause the processor to perform the steps of:
obtaining patient data,
assessing a clinical need of the patient,
proposing a clinical outcome, and
determining a service to be provided to the patient for said clinical need and said proposed clinical outcome based on a service-outcome-need model, wherein the service-outcome-need model provides a relationship between a service provided to the patient, a clinical outcome and a clinical need of the patient.

2. (canceled)

3. The healthcare support system as claimed in claim 1, wherein the service-outcome-need model further comprises an ontology, which ontology gives a relationship of clinical needs for a clinical domain or a disease.

4. The healthcare support system as claimed in claim 1, further comprising a service database wherein for each service there is an instance of the service-outcome-need model.

5. The healthcare support system as claimed in claim 4, wherein the instructions further cause the processor to perform the step of creating said service database based on patient data.

6. The healthcare support system as claimed in claim 5, wherein said creation of said service database further comprises obtaining data from clinical studies and/or clinical experts.

7. The healthcare support system as claimed in claim 4, wherein the instructions further cause the processor to perform the step of updating said service database based on the obtained data.

8. The healthcare support system as claimed in claim 1, wherein said healthcare support system is a self-adapting system, wherein the system continuously determines the most appropriate service to be provided to the patient.

9. The healthcare support system as claimed in claim 1, wherein the patient data is obtained based on elements selected for a patient summary.

10. The healthcare support system as claimed in claim 1, wherein the determination of the service to be provided to the patient is further based on elements selected for a patient summary.

11. The healthcare support system as claimed in claim 1, wherein the patient data comprises psycho-social data and wherein the step of determining a service to be provided to the patient further comprises determining how the service is to be provided based on the psycho-social data.

12. A healthcare support system for determining care for a patient, the system comprising a processor and a computer-readable storage medium, wherein the computer-readable storage medium contains instructions for execution by the processor, wherein the instructions cause the processor to perform the steps of:
obtaining patient data, wherein the patient data comprises psycho-social data,
assessing a clinical need of the patient, and
determining a service to be provided to the patient for said clinical need and determining how the service is to be provided to the patient based on the psycho-social data.

13. A healthcare support method for determining care for a patient comprising the steps of:
obtaining patient data,
assessing a clinical need of the patient,
proposing a clinical outcome, and
determining a service to be provided to the patient for said clinical need and said proposed clinical outcome based on a service-outcome-need model, wherein the service-outcome-need model provides a relationship between a service provided to the patient, a clinical outcome and a clinical need of the patient.

14. Computer program comprising program code means for causing a computer to carry out the steps of the method as claimed in claim 13 when said computer program is carried out on the computer.

15. A healthcare support system for determining care for a patient comprising:
means for obtaining patient data,
means for assessing a clinical need of the patient,
means for proposing a clinical outcome, and
means for determining a service to be provided to the patient for said clinical need and said proposed clinical outcome based on a service-outcome-need model, wherein the service-outcome-need model provides a relationship between a service provided to the patient, a clinical outcome and a clinical need of the patient.
